(19) United States
(12) Patent Application Publication
(10) Pub. No.: US 2007/0291171 A1
(43) Pub. Date: Dec. 20, 2007

(54) Channel combining

(75) Inventor: Clint Allen Neal, Quincy, IL (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Harris Corporation

(21) Appl. No.: 11/455,876

(22) Filed: Jun. 19, 2006

(51) Int. Cl. H04N 7/12; H04N 5/38

(52) U.S. Cl. 348/487; 348/723

(57) ABSTRACT

A filter-combiner for combining television signals from adjacent channels. The combiner has two inputs that respectively receive first and second TV signals from different channels, and provides a combined output signal at an output of the combiner. The combiner includes a circulator having at least three ports, including first and second input ports and an output port serving as the combiner output. The combiner has sharp tuned filtering means interposed between the combiner input and the first input of the circulator tuned to pass the first signal while reflecting substantially all of the second signal. The second port of the circulator receives the second signal and supplies same to the filter where it is reflected back into the second port and exits from the circulator along with the first signal at the output port as the combined output signal.

### BACKGROUND OF THE INVENTION

The present invention relates to radio frequency (RF) broadcasting and, more particularly, to the employment of a sharply tuned bandpass filter and a circulator.

### DESCRIPTION OF THE PRIOR ART

Television signals have traditionally been broadcast in an analog format known as NTSC. The Federal Communications Commission (FCC) is now permitting a new digital format known as DTV. The digital format is presently in operation and the FCC has provided a transitional period during which the NTSC signals and the DTV signals will both be transmitted. Thus, a station will simulcast both an NTSC signal and a DTV signal. It is understood that the FCC has allocated frequency bands or channels wherein an NTSC signal will be adjacent a DTV signal and also that a DTV signal will be adjacent to another DTV signal. In the United States, the channels are all 6 MHz wide, whereas in other parts of the world the channels are 6-8 MHz wide. The discussion presented herein is specifically directed to channels that are 6 MHz wide although it is to be understood that the discussion may be similar for channels that are up to 8 MHz wide.

When a DTV allocation is one channel below an NTSC channel, this is referred to as the N−1 case. When the DTV allocation is one channel above an NTSC channel, this is referred to as the N+1 case.

A filter-combiner in the prior art is disclosed in U.S. Pat. No. 6,933,986 to R. J. Plonka, the disclosure of which is hereby incorporated by reference.

The filter-combiner disclosed in that patent is used in an RF broadcasting system and includes a pair of sharp-tuned filters together with an input hybrid and an output hybrid for combining two signals from adjacent or spaced apart channels such as two DTV channels or a DTV and an NTSC channel.

### SUMMARY OF THE INVENTION

In accordance with one aspect of the present invention, an improved filter-combiner is provided for combining television signals. This combiner includes two inputs that respectively receive first and second TV signals from different channels and provide therefrom a combined output signal at an output of the combiner. The combiner includes a circulator that has at least three ports, including first and second ports and an output port, serving as the combiner output. The combiner has sharp tuned filtering means interposed between the combiner input and the first input of the circulator which is tuned to pass the first signal while reflecting all of the second signal. The second port of the combiner receives the second signal and supplies it to the filter where it is reflected back into the second port and exits from the circulator along with the first signal as a combined output signal.

### BRIEF DESCRIPTION OF THE DRAWINGS

The foregoing and other objects and advantages of the present invention will become more readily apparent from the following as taken in conjunction with the accompanying drawings, wherein:

FIG. 1 is a block diagram illustration of a filter-combiner in accordance with the prior art;

FIG. 2 is a block diagram illustration of an embodiment of the invention herein;

FIG. 3 is a block diagram illustration of a second embodiment of the invention herein;

FIG. 4 is a block diagram of a third embodiment of the invention herein;

FIG. 5 is a block diagram of another embodiment of the invention herein;

FIG. 6 is a graphic illustration of amplitude with respect to frequency and illustrating a typical filter specification for amplitude response and also including the FCC mask and the sharp tuned filter mask herein; and

FIG. 7 is a graphic illustration of time in nanoseconds versus frequency and illustrating filter specifications with respect to group delay.

### DESCRIPTION OF PREFERRED EMBODIMENTS

Reference is now made to FIG. 1 which illustrates a prior art filter-combiner which may be employed for combining a DTV signal and NTSC signal. This prior art combiner is found at FIG. 8 in the U.S. Pat. No. 6,933,986 to R. J. Plonka, the disclosure of which is incorporated herein by reference. As shown in FIG. 1, this filter-combiner 100 employs a pair of filters 102 and 104, each constructed in the same manner. Each is described herein as a sharp tuned filter (STF). Such a filter is described in greater detail hereinafter and further details may be obtained from the aforesaid Plonka patent. Each filter 102 and 104 is tuned so as to pass RF television signals within a particular channel while rejecting all other RF frequencies.

At this point, a definition is required for a clear understanding of the following discussion. When a DTV allocation is one channel below NTSC channel, this is referred to as an N−1 case. When the DTV allocation is one channel above the NTSC channel, this is referred to as the N+1 case.

The example presented in FIG. 1 is for the N+1 case. Thus, a DTV signal is from a channel of higher frequencies than the NTSC channel. For example, the DTV channel may be that for channel 10 and the NTSC channel may be that for channel 9. In the example presented in FIG. 1, both filters 102 and 104 are tuned to pass the DTV signal (channel 10) while rejecting all other RF frequencies. The DTV signal is supplied to a power amplifier 111 and, thence, to an input port 113 at the left side of a hybrid 115. Another port 117 of hybrid 115 is connected to a reject load 119. The DTV signal enters the hybrid at the input port 113 and then is split into two portions which are respectively passed by filters 102 and 104 and enter a right hybrid 121 and are recombined and are supplied to an output port 123. The NTSC signal, including both audio and video components, is supplied to a port 125 on the right side of hybrid 121. The signal is then split in the hybrid 121 and portions exit on the left side of the hybrid 121 and are reflected from filters 102 and 104 and reenter the hybrid 121 and recombine along with the recombined DTV signal and are provided at output port 123 and applied to a load, such as antenna 131.

The filter-combiner of the prior art shown in FIG. 1 employs two hybrids and two sharp tuned filters 102 and 104. The present invention is directed toward improving upon that illustrated in FIG. 1 and reference is now made to the description which follows.

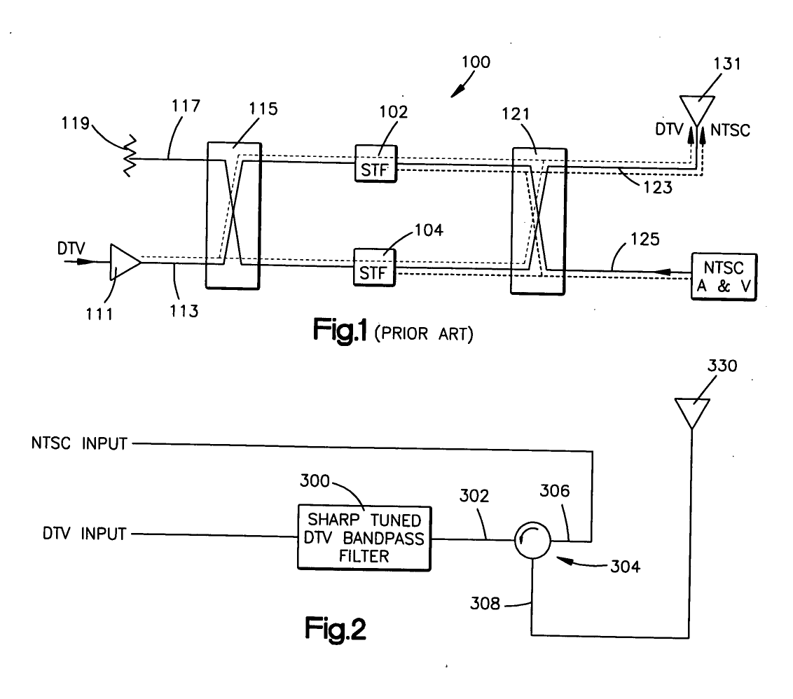

Reference is now made to FIG. 2 which illustrates one embodiment of the present invention and which employs a single sharp tuned filter 300 which may be constructed essentially identical to that of either filter 102 or 104. This sharp tuned filter has its input connected to receive a DTV signal and its output connected to a first port 302 of a circulator 304 which has a second port 306 that receives an NTSC signal as an input. The circulator has an output port 308 that supplies a combined output signal to an antenna 330.

In this embodiment, a transmitter provides a DTV signal as an input to the sharp tuned filter 300 which allows the DTV signal to pass through while reflecting the side band energy back to the transmitter. This allows a clean DTV signal to go to input port 302 into the circulator 304. The directional nature of the circulator 304 passes the DTV signal through the output port 308 and, thence, to the antenna 330. The NTSC signal obtained from the transmitter is supplied to port 306 and, thence, into the circulator 304. The circulator passes the NTSC signal through port 302 to the sharp tuned filter 300 where the NTSC signal is reflected back through the circulator 304 and out from port 308 to the antenna 330.

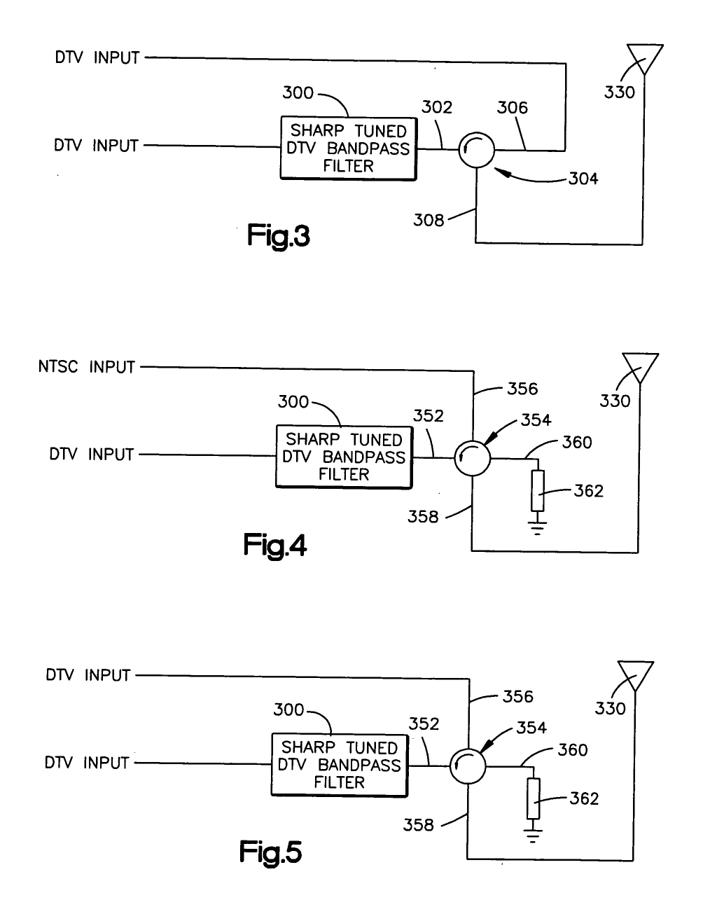

The embodiment illustrated in FIG. 3 is similar to that in FIG. 2 as each includes a three port circulator 304 having ports 302, 306 and 308. In this embodiment, an DTV signal is supplied as the input to the sharp tuned filter 300 which is then passed by the filter to the circulator 304 and exits from port 308 to the antenna 330. The second DTV signal is supplied from a transmitter to the port 306 of circulator 304. The DTV signal exits from port 308 and is supplied to the antenna 330 in the same manner as described with reference to the embodiment of FIG. 2.

Reference is now made to FIG. 4. This embodiment is similar to that of the embodiment in FIG. 2, except that it embodies a four port circulator 354 instead of the three port circulator 304 of FIGS. 2 and 3. In this embodiment the circulator 354 includes ports 352, 356 and 358 which respectively correspond with ports 302, 306 and 308 of circulator 304 in FIG. 2. However, in this embodiment there is a fourth port 360 so that any power reflected from the antenna will be routed to the load 362. This isolates both transmitter inputs from power being reflected from the antenna.

FIG. 5 is another embodiment similar to that of FIG. 4 in that it employs a four port circulator. However, as in the example of FIG. 3, one DTV signal is supplied to filter 300 and the second DTV signal is supplied to port 356 of the circulator.

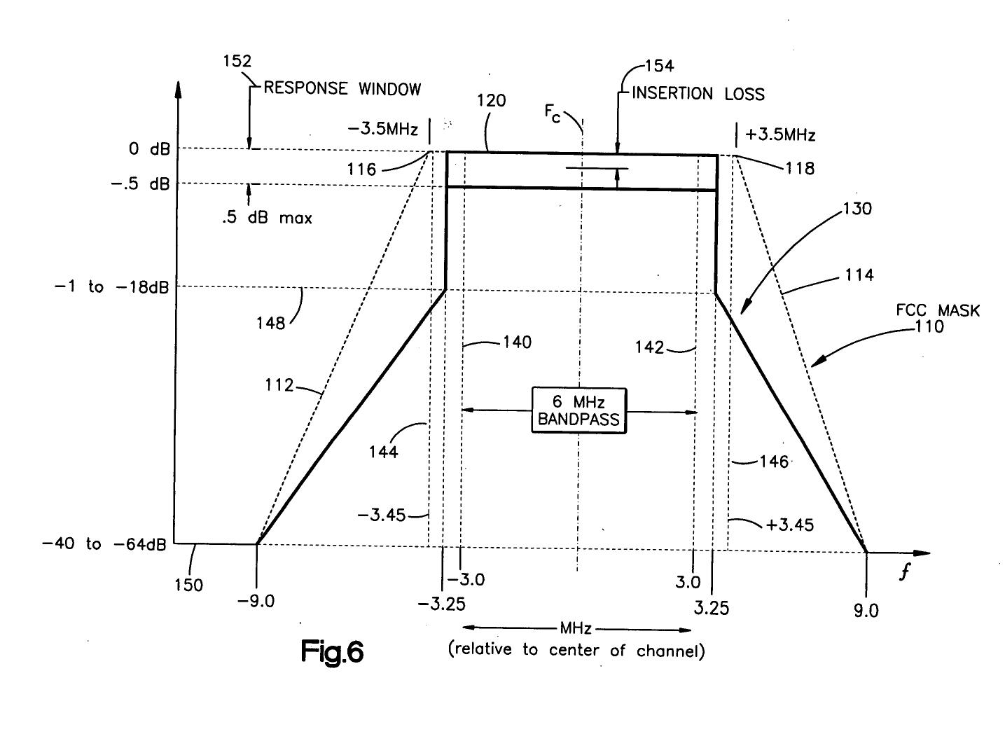

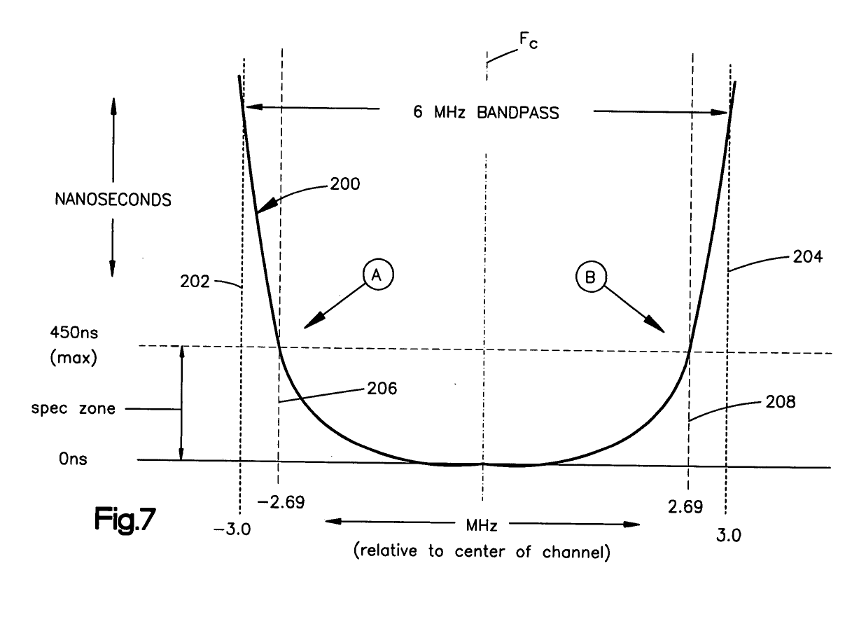

The sharp tuned filters 300 disclosed herein take the form of filters 102 and 104 shown in FIG. 1 and, in turn, each of these filters is constructed as described in the Plonka patent. FIGS. 6 and 7 herein respectively correspond with FIGS. 5 and 6 in the Plonka patent. The following description, along with that presented in the aforesaid Plonka patent, provides a description of these filters.

In FIG. 6 there is illustrated, in dotted lines, the FCC mask 110 for DTV signals sometimes known as the 8VSB standard or the 8VSB modulated RF signal. The Federal Communications Commission (FCC) has mandated that each television channel have a bandwidth of 6 MHz whether the channel be a DTV channel or an NTSC channel. The FCC mask 110 requires that all signals broadcasted have their power attenuated starting at frequencies no greater than ±3.5 MHz relative to the center frequency Fc of the assigned channel. The attenuation is complete. The FCC mask, as shown in FIG. 6, requires that the attenuation be continuous within the mask. The mask has left and right skirts 112 and 114 that extend in a linear fashion from mask edges 116 and 118 from the in-band power level 120 to −64 dB at ±9 MHz relative to the center frequency Fc. The in-band power level 120 will sometimes be referred to herein as the reference level.

The filter 102 complies with and falls within the mandated FCC mask as is indicated herein by the solid line 130 representing the filter mask. This shows the amplitude response of the filter. The vertical dashed lines 140 and 142 represent the 6 MHz bandpass from −3.0 to ±3.0 MHz relative to the center line frequency Fc that must be passed by the filter. Attenuation of signals beyond ±3.0 MHz up to about ±3.45 MHz, as indicated by the dashed lines 144 and 146, is achieved by the filter. This attenuation is uniform about the center frequency extending downward to an attenuated level as indicated by the horizontal dashed line 148 and this attenuated level is at about −1 to −18 dB from the in-band power level 120. From this attenuated level, the amplitude response is further attenuated in a skirt like fashion to a level 150 of about −40 dB to −64 dB at ±9 MHz relative to the center line frequency Fc.

There may be some amplitude ripple at the in-band power level 120, however, this should stay within a response window 152 and not exceed about −0.5 dB below the in-band power level 120. Additionally, the insertion loss 154 should not exceed about −0.20 dB from the in-band power level 120.

Reference is now made to FIG. 7 which presents a graphical illustration of time with respect to frequency showing the group delay as represented by curve 200 within the 6 MHz bandpass as represented by vertical dashed lines 202 and 204 at −3.0 and +3.0 MHz relative to the center frequency Fc. Points A and B are taken at −2.69 and +2.69 MHz relative to the center frequency Fc as indicated by the vertical dashed lines 206 and 208. These lines 206 and 208 intersect curve 200 at points A and B which are to be kept within 50 nanoseconds of each other.

The specifications of the filter 102 as presented in FIGS. 6 and 7 and as discussed above have been presented relative to the standards in the United States wherein the FCC has allocated television channels as being 6.0 MHz wide. The European and other non-U.S. standards differ somewhat and, for example, the bandpass filter must be modified to pass frequencies on the order of 6 to 8.0 MHz which is the channel width or bandwidth in other parts of the world. Consequently, if the bandwidth of each channel is designated as being on the order of W MHz, then W may be 6 for the United States and 6 to 8 MHz for other parts of the world.

Although the foregoing has been described in conjunction with a preferred embodiment, it is to be appreciated that various modifications may be made without departing from the spirit and scope of the invention as defined by the appended claims.

Having described the invention, we claim the following:

1. A filter-combiner for combining television signals from adjacent channels comprising:
said combiner having two inputs that respectively receive first and second TV signals from different channels, and providing a combined output signal at an output of said combiner;
said combiner including a circulator having at least three ports, including first and second input ports and an output port serving as said combiner output;
said combiner having sharp tuned filtering means interposed between said combiner input and said first input of said circulator tuned to pass said first signal while reflecting substantially all of said second signal;
said second port of said circulator receiving said second signal and supplying same to said filter where it is reflected back into said second port and exits from said circulator along with said first signal at said output port as said combined output signal.

2. A filter-combiner as set forth in claim 1 wherein said first TV signal is an NTSC combined visual and aural signal and said second TV signal is a DTV signal.

3. A filter-combiner as set forth in claim 1 wherein said first and second TV signals are from adjacent TV channels.

4. A filter-combiner as set forth in claim 3 wherein said first TV signal is an NTSC combined visual and aural signal and said second TV signal is a DTV signal.

5. A filter-combiner as set forth in claim 1 wherein said first TV signal is of a greater frequency than said second TV signal.

6. A filter-combiner as set forth in claim 5 wherein said first and second TV signals are from adjacent channels.

7. A filter-combiner as set forth in claim 6 wherein said first TV signal is an NTSC signal and said second TV signal is a DTV signal.

8. A filter-combiner as set forth in claim 7 wherein the bandwidth of each said channel is on the order of W MHz.

9. A filter-combiner as set forth in claim 8 wherein W is in the range of from about 6.0 MHz to about 8.0 MHz.

10. A filter-combiner as set forth in claim 8 wherein W equals 6.0 MHz.

11. A filter-combiner as set forth in claim 8 wherein said mandated mask is the federal communications commission (FCC) mask.
